(19) United States
(12) Patent Application Publication
(10) Pub. No.: US 2017/0336671 A1
(43) Pub. Date: Nov. 23, 2017

(54) DISPLAY DEVICE

(71) Applicant: Samsung Display Co., Ltd, Yongin-si (KR)

(72) Inventors: Seungbo SHIM, Asan-si (KR); Hyunsoo RYU, Daejeon (KR); Sejoon OH, Suwon-si (KR); Hyewon JANG, Asan-si (KR)

(21) Appl. No.: 15/461,191

(22) Filed: Mar. 16, 2017

(30) Foreign Application Priority Data
May 18, 2016 (KR) 10-2016-0060823

(51) Int. Cl. G02F 1/1335; G02F 1/1339; G02F 1/1333; G02F 1/1362

(52) U.S. Cl. CPC G02F 1/133514; G02F 1/136286; G02F 1/133512; G02F 1/1339; G02F 1/133345; G02F 2201/121; G02F 2201/503; G02F 2202/02

(57) ABSTRACT

A display device includes: a first substrate and a second substrate opposing each other; a common voltage applying line on the first substrate; a common electrode on the second substrate; and a short circuit unit between the common voltage applying line and the common electrode. The short circuit unit includes: a protruding portion on the common voltage applying line; and a short circuit electrode on the protruding portion, the protruding portion includes at least one dummy color filter defining a groove, and the short circuit electrode is electrically connected to the common voltage applying line and the common electrode.

This application claims priority to Korean Patent Application No. 10-2016-0060823, filed on May 18, 2016, and all the benefits accruing therefrom under 35 U.S.C. §119, the content of which in their entirety is herein incorporated by reference.

### BACKGROUND

### 1. Field

Exemplary embodiments of the invention relate to a display device, and more particularly, to a display device including an organic layer.

### 2. Description of the Related Art

Display devices are classified into a liquid crystal display (“LCD”) device, an organic light emitting diode (“OLED”) display device, a plasma display panel (“PDP”) device, an electrophoretic display (“EPD”) device, and the like, based on a light emitting scheme thereof.

Among the types of display devices, LCD devices are one of most widely used types of flat panel display (“FPD”) devices. An LCD device includes two substrates, which themselves include two electrodes respectively formed thereon and a liquid crystal layer interposed therebetween. Upon applying voltage to the two electrodes, liquid crystal molecules of the liquid crystal layer are rearranged such that an amount of transmitted light is controlled in the LCD device.

In recent times, a technology is being developed in order to simplify a process, whereby an organic material is directly patterned to form an organic layer and a display device including the organic layer.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Exemplary embodiments of the invention are directed to a display device including an organic layer which is formed substantially not including pores, and improved in terms of display quality.

Further, exemplary embodiments of the invention are directed to a display device in which an organic material is coated without generating pores in a process of manufacturing the display device.

According to an exemplary embodiment of the invention, a display device includes: a first substrate and a second substrate opposing each other; a common voltage applying line on the first substrate; a common electrode on the second substrate; and a short circuit unit between the common voltage applying line and the common electrode. The short circuit unit includes: a protruding portion on the common voltage applying line; and a short circuit electrode on the protruding portion, wherein the protruding portion includes at least one dummy color filter defining a groove, and wherein the short circuit electrode is electrically connected to the common voltage applying line and the common electrode.

The groove may be defined by removing at least a portion of the at least one dummy color filter.

The at least one dummy color filter may include at least one of a red color filter, a green color filter, and a blue color filter.

The groove may have a slit shape.

The first substrate may include a display area and a non-display area, and the slit shape may extend from the non-display area toward the display area.

The groove may have a mesh shape, and the at least one dummy color filter may be disposed in an island shape.

The groove may have a width ranging from about 1 μm to about 10 μm.

The groove may have a depth ranging from about 0.5 μm to about 3 μm.

The first substrate may include a display area and a non-display area, and the short circuit unit may be disposed in the non-display area.

The short circuit unit may further include an organic layer between the protruding portion and the short circuit electrode.

The organic layer may be a passivation layer.

The display device may further include a sealing portion between the short circuit unit and the common electrode, and wherein the sealing portion may include a conductive ball.

The display device may further include a light blocking portion on the first substrate. The short circuit unit may have a greater height than a height of the light blocking portion with respect to a surface of the first substrate.

The short circuit unit may have a height ranging from about 4.5 μm to about 9.0 μm with respect to a surface of the first substrate.

The display device may further include a data line and a gate line on the first substrate. The common voltage applying line may be disposed on a same layer as a layer on which the gate line is disposed.

The protruding portion may further include a gate insulating layer on the common voltage applying line and a conductive layer on the gate insulating layer, and the conductive layer may be disposed on a same layer as a layer on which the data line is disposed.

The display device may further include a liquid crystal layer between the first substrate and the second substrate.

According to an exemplary embodiment of the invention, a display device includes: a first substrate and a second substrate opposing each other; a common voltage applying line on the first substrate; a common electrode on the second substrate; and a short circuit unit between the common voltage applying line and the common electrode. The short circuit unit includes: a protruding portion on the common voltage applying line; and a short circuit electrode disposed on the protruding portion and electrically connected to the common voltage applying line and the common electrode, and wherein the protruding portion includes: a first dummy color filter on the common voltage applying line; a second dummy color filter on the first dummy color filter; and a groove which is defined by removing at least a portion of at least one of the first dummy color filter and the second dummy color filter.

Each of the first dummy color filter and the second dummy color filter may be one of a red color filter, a green color filter, and a blue color filter.

The groove may pass through the first dummy color filter and the second dummy color filter.

The groove may be defined by removing at least a portion of the first dummy color filter, and the second dummy color filter may be disposed on the first color filter and in the groove.

The second dummy color filter may cover a side wall of the groove.

The groove may have a slit shape.

The display device may further include a light blocking portion on the first substrate. The short circuit unit may have a greater height than a height of the light blocking portion with respect to a surface of the first substrate.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of invention will be more clearly understood from the following detailed description taken in conjunction with the accompanying drawings, in which:

FIG. 1 is a plan view illustrating a first exemplary embodiment of a display device;

FIG. 2 is a plan view illustrating an area “A” of FIG. 1;

FIG. 3 is a cross-sectional view taken along line I-I′ of FIG. 2;

FIG. 4 is a plan view illustrating an area “B” of FIG. 1;

FIG. 5 is a cross-sectional view taken along line II-II′ of FIG. 4;

FIG. 6 is a cross-sectional view taken along line II-III′ of FIG. 4;

FIG. 7A is an enlarged plan view illustrating a portion “P1” of FIG. 4, and FIG. 7B is a perspective view illustrating the portion “P1” of FIG. 4;

FIG. 8A is a plan view illustrating a protruding portion of a second exemplary embodiment of a display device, and FIG. 8B is a cross-sectional view taken along line C2-C2′ of FIG. 8A;

FIG. 9A is a plan view illustrating a protruding portion of a third exemplary embodiment of a display device, and FIG. 9B is a cross-sectional view taken along line C3-C3′ of FIG. 9A;

FIG. 10A is a plan view illustrating a protruding portion of a fourth exemplary embodiment of a display device, and FIG. 10B is a cross-sectional view taken along line C4-C4′ of FIG. 10A;

FIG. 11A is a plan view illustrating a protruding portion of a fifth exemplary embodiment of a display device, and FIG. 11B is a cross-sectional view taken along line C5-05′ of FIG. 11A;

FIG. 12A is a plan view illustrating a protruding portion of a sixth exemplary embodiment of a display device, and FIG. 12B is a cross-sectional view taken along line C6-C6′ of FIG. 12A;

FIG. 13A is a plan view illustrating a protruding portion of a seventh exemplary embodiment of a display device, and FIG. 13B is a cross-sectional view taken along line C7-C7′ of FIG. 13A;

FIG. 14A is a plan view illustrating a protruding portion of an eighth exemplary embodiment of a display device, and FIG. 14B is a cross-sectional view taken along line C8-C8′ of FIG. 14A;

FIG. 15A is a plan view illustrating a protruding portion of a ninth exemplary embodiment of a display device, and FIG. 15B is a cross-sectional view taken along line C9-C9′ of FIG. 15A;

FIG. 16A is a plan view illustrating a protruding portion of a tenth exemplary embodiment of a display device, and FIG. 16B is a cross-sectional view taken along line C10-C10′ of FIG. 16A;

FIG. 17A is a plan view illustrating a protruding portion of an eleventh exemplary embodiment of a display device, and FIG. 17B is a cross-sectional view taken along line C11-C11′ of FIG. 17A;

FIG. 18 is a cross-sectional view illustrating an example of coating an organic material; and

FIG. 19 is a cross-sectional view illustrating an example of pores being generated in the process of coating the organic material.

### DETAILED DESCRIPTION

Exemplary embodiments will now be described more fully hereinafter with reference to the accompanying drawings. Although the invention can be modified in various manners and have several embodiments, exemplary embodiments are illustrated in the accompanying drawings and will be mainly described in the specification. However, the scope of the invention is not limited to the exemplary embodiments and should be construed as including all the changes, equivalents, and substitutions included in the spirit and scope of the invention.

In the drawings, certain elements or shapes may be illustrated in an enlarged manner or in a simplified manner to better illustrate the invention, and other elements present in an actual product may also be omitted. Thus, the drawings are intended to facilitate the understanding of the present invention.

When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “less”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within±30%, 20%, 10%, 5% of the stated value.

Unless otherwise defined, all terms used herein (including technical and scientific terms) have a same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Hereinafter, a first exemplary embodiment will be described in detail with reference to accompanying drawings.

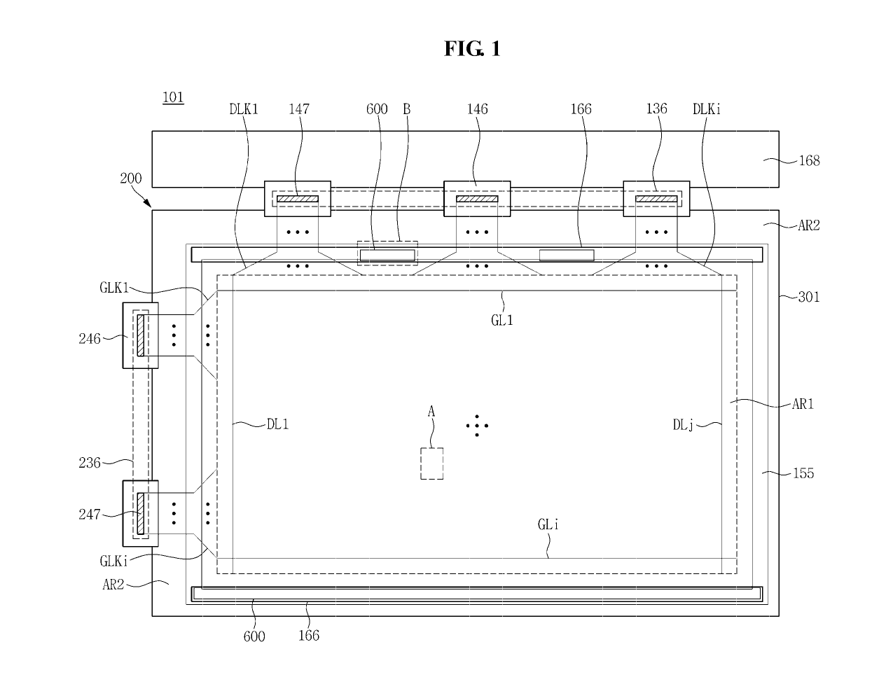

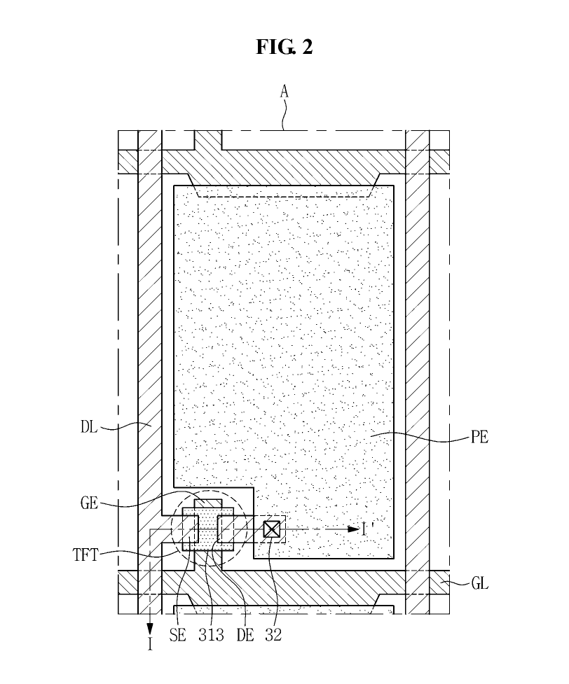

FIG. 1 is a plan view illustrating a first exemplary embodiment of a display device, FIG. 2 is a plan view illustrating an area “A” of FIG. 1, and FIG. 3 is a cross-sectional view taken along line I-I′ of FIG. 2.

The first exemplary embodiment of a display device is a liquid crystal display (“LCD”) device 101. However, the first exemplary embodiment is not limited to the LCD device, and the first exemplary embodiment may also be applied to an organic light emitting diode (“OLED”) display device.

As illustrated in FIG. 1, the first exemplary embodiment of the LCD device 101 includes a display panel 200, a gate driver 236, and a data driver 136.

As illustrated in FIGS. 1 and 3, the display panel 200 includes a display substrate 210, an opposing substrate 220, a liquid crystal layer LC, and a sealing portion 155. The display panel 200 is divided into a display area AR1 and a non-display area AR2. The display area AR1 and the non-display area AR2 of the display panel 200 correspond to a display area AR1 and a non-display area AR2 of a first substrate 301, respectively.

The sealing portion 155 is disposed between the display substrate 210 and the opposing substrate 220 and in the non-display area AR2. For example, as illustrated in FIG. 1, the sealing portion 155 may have a closed-loop shape surrounding the display area AR1.

The liquid crystal layer LC is disposed in a space defined by the display substrate 210, the opposing substrate 220, and the sealing portion 155. The liquid crystal layer LC may include liquid crystal molecules and may include a photopolymerizable material.

Referring to FIGS. 1 and 3, the display substrate 210 includes the first substrate 301, and a plurality of gate lines GL1 to GLi, a plurality of data lines DL1 to DLj, and a common voltage applying line 166 on the first substrate 301.

The data lines DL1 to DLj intersect the gate lines GL1 to GLi. The gate lines GL1 to GLi extend to the non-display area AR2 to be connected to the gate driver 236, and the data lines DL1 to DLj extend to the non-display area AR2 to be connected to the data driver 136.

A portion of each of the gate lines GL1 to Gli in the non-display area AR2 may be defined as gate link lines GLK1 to GLKi. Each of the gate link lines GLK1 to GLKi intersects the sealing portion 155. A portion of each of the data lines DL1 to Dlj in the non-display area AR2 may be defined as data link lines DLK1 to DLKi. Each of the data link lines DLK1 to DLKj intersects the sealing portion 155.

The gate driver 236 includes a plurality of gate driving integrated circuits 247. The gate driving integrated circuits 247 generate gate signals and sequentially provide the gate signals to the first to i-th gate lines GL1 to GLi. Hereinafter, the gate lines will be represented by a reference mark “GL.”

Each of the gate driving integrated circuits 247 may be mounted on a gate carrier 246. The gate carrier 246 may be a gate tape carrier package.

The data driver 136 includes a plurality of data driving integrated circuits 147. The data driving integrated circuits 147 receive image data signals and a data control signal from a timing controller (not illustrated), and apply the image data signals to the data lines DL1 to DLj according to the data control signal.

Each of the data driving integrated circuits 147 is mounted on a data carrier 146. The data carriers 146 are connected between a circuit board 168 and the display substrate 210. The data carrier 146 may be a data tape carrier package.

The timing controller and the power supplier may be disposed on the circuit board 168. The data carrier 146 includes input wirings which transmit various signals applied from the timing controller and the power supplier to the data driving integrated circuit 147 and output wirings which transmit the image data signals output from the data driving integrated circuit 147 to corresponding ones of the data lines DL1 to DLj. In an exemplary embodiment, at least one data carrier 146 may further include auxiliary wirings which may transmit various signals applied from the timing controller and the power supplier to the gate driver 236. Hereinafter, the data line will be represented by a reference mark “DL.”

The common voltage applying line 166 disposed on the first substrate 301 may overlap the sealing portion 155. As illustrated in FIG. 1, the common voltage applying line 166 is absent from an overlapping area among the sealing portion 155 and the gate link lines GLK1 to GLKi.

On the other hand, the common voltage applying line 166 is disposed on a different layer from a layer on which the data link lines DLK1 to DLKj are disposed, and thus may be disposed at an overlapping area among the sealing portion 155 and the data link lines DLK1 to DLKj. However, in such an exemplary embodiment, a capacitor may be formed among the common voltage applying line 166 and the data link lines DLK1 to DLKj, and such a capacitor may affect the image data signal of the data lines DL1 to DLj. Accordingly, the common voltage applying line 166 may not be disposed at the overlapping area among the sealing portion 155 and the data link lines DLK1 to DLKj.

The common voltage applying line 166 receives a common voltage from the aforementioned power supplier. To this end, the common voltage applying line 166 may be connected to the power supplier through at least one of a signal transmission line in the gate carrier 246 and a signal transmission line in the data carrier 146. The common voltage applying line 166 is connected to a common electrode CE of the opposing substrate 220 through a short circuit unit 600, and applies the common voltage to the common electrode CE through the short circuit unit 600 (refer to FIG. 6).

The display panel 200 includes a plurality of pixels. The pixels are disposed in the display area AR1 of the display panel 200. The pixels are arranged in a matrix form. Each of the pixels is connected to the gate line GL and the data line DL. An area “A” illustrated in FIG. 2 includes one pixel area.

As illustrated in FIGS. 1 and 3, the display substrate 210 includes, on the first substrate 301, the gate line GL, the data line DL, the common voltage applying line 166, a thin film transistor (“TFT”), a gate insulating layer 331, an insulating interlayer 320, a color filter 351 and 352, an organic layer 391, a pixel electrode PE, a light blocking portion 376, and the short circuit unit 600.

The gate line GL, a gate electrode GE, and the common voltage applying line 166 may be disposed on a same layer. An end portion of the gate line GL may be connected to another layer or an external driving circuit, and to this end, the end portion of the gate line GL may have a larger planar area than that of another portion of the gate line GL.

At least one of the gate line GL, the gate electrode GE, and the common voltage applying line 166 may include or be formed of aluminum (Al) or alloys thereof, silver (Ag) or alloys thereof, copper (Cu) or alloys thereof, and/or molybdenum (Mo) or alloys thereof. In an alternative exemplary embodiment, at least one of the gate line GL, the gate electrode GE, and the common voltage applying line 166 may include or be formed of one of chromium (Cr), tantalum (Ta), and titanium (Ti). In addition, at least one of the gate line GL, the gate electrode GE, and the common voltage applying line 166 may have a multilayer structure including at least two conductive layers that have different physical properties from one another.

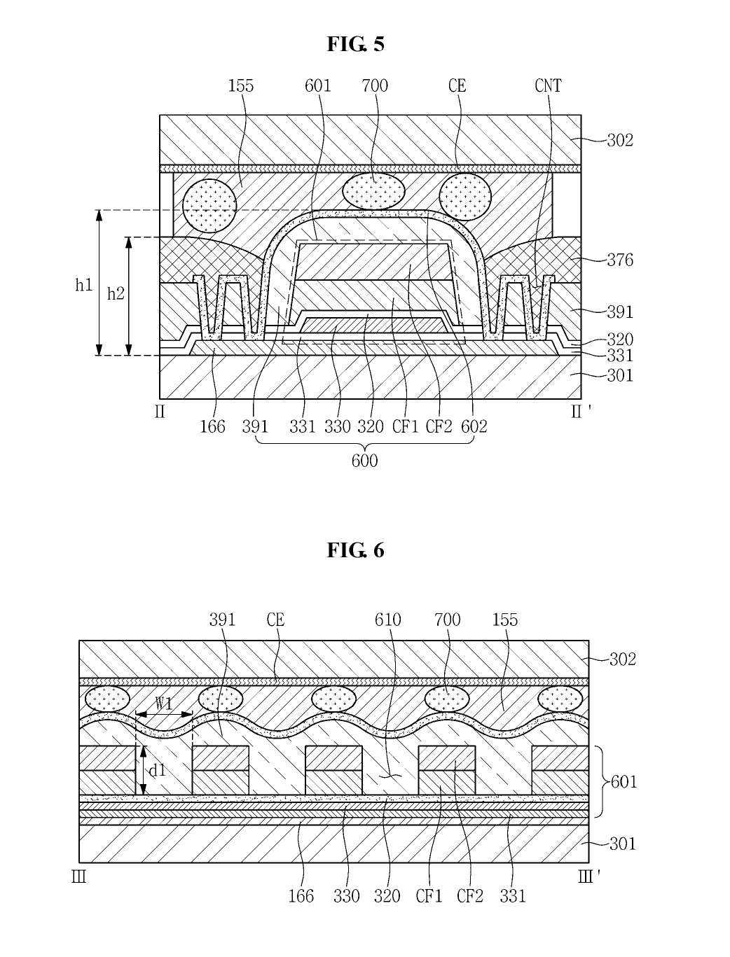

The gate insulating layer 331 is disposed on the gate line GL, the gate electrode GE, and the common voltage applying line 166. In such an exemplary embodiment, the gate insulating layer 331 may be disposed over an entire surface of the first substrate 301 including the gate line GL, the gate electrode GE, and the common voltage applying line 166. Referring to FIG. 5, the gate insulating layer 331 has an aperture defined corresponding to a short circuit contact hole CNT. The common voltage applying line 166 is exposed through the short circuit contact hole CNT.

The gate insulating layer 331 may include or be formed of silicon nitride (SiNₓ) and/or silicon oxide (SiOₓ). The gate insulating layer 331 may have a multilayer structure including at least two insulating layers having different physical properties.

A semiconductor layer 313 is disposed on the gate insulating layer 331. The semiconductor layer 313 overlaps the gate electrode GE, the source electrode SE, and the drain electrode DE. The semiconductor layer 313 may include amorphous silicon, polycrystalline silicon, or the like. The semiconductor layer 313 may include an oxide semiconductor material.

An ohmic contact layer (not illustrated) may be disposed on the semiconductor layer 313.

The source electrode SE is disposed to overlap a portion of the semiconductor layer 313. The source electrode SE extends from the data line DL. For example, as illustrated in FIG. 2, the source electrode SE has a shape protruding from the data line DL toward the gate electrode GE.

The source electrode SE may include or be formed of a refractory metal, such as molybdenum, chromium, tantalum, and titanium, or an alloy thereof, and may have a multilayer structure including a refractory metal layer and a low-resistance conductive layer. Examples of the multilayer structure may include: a double-layer structure including a chromium or molybdenum (alloy) lower layer and an aluminum (alloy) upper layer; and a triple-layer structure including a molybdenum (alloy) lower layer, an aluminum (alloy) intermediate layer, and a molybdenum (alloy) upper layer. In an alternative exemplary embodiment, the source electrode SE may include or be formed of any suitable metals or conductors rather than the aforementioned materials.

Spaced apart from the source electrode SE, the drain electrode DE is disposed to overlap a portion of the semiconductor layer 313. The drain electrode DE is connected to the pixel electrode PE. The drain electrode DE and the source electrode SE may be simultaneously provided in a same process.

A thin film transistor (TFT) is defined by the gate electrode GE, the semiconductor layer 313, the source electrode SE, and the drain electrode DE.

A channel area of the TFT is disposed at a portion of the semiconductor layer 313 between the source electrode SE and the drain electrode DE.

The data line DL is disposed on the gate insulating layer 331. An end portion of the data line DL may be connected to another layer or an external driving circuit, and to this end, the end portion of the data line DL may have a larger planar area than that of another portion of the data line DL.

The data line DL intersects the gate line GL. Although not illustrated, a portion of the data line DL intersecting the gate line GL may have a smaller line width than that of another portion of the data line DL. Accordingly, a parasitic capacitance between the data line DL and the gate line GL may be reduced. The data line DL may include a same material and have a same structure (a multilayer structure) as those of the source electrode SE. In other words, the data line DL and the source electrode SE may be simultaneously provided in a same process.

Although not illustrated, the semiconductor layer 313 may further be disposed between the gate insulating layer 331 and the source electrode SE and between the gate insulating layer 331 and the drain electrode DE. Although not illustrated, the semiconductor layer 313 may further be disposed between the gate insulating layer 331 and the data line DL.

The insulating interlayer 320 is disposed on the data line DL, the source electrode SE, the drain electrode DE, and the gate insulating layer 331. In such an exemplary embodiment, the insulating interlayer 320 may be disposed over an entire surface of the first substrate 301 including being disposed over the data line DL, the source electrode SE, the drain electrode DE, and the gate insulating layer 331. Referring to FIGS. 3 and 5, the insulating interlayer 320 is defined with apertures which are defined corresponding to a drain contact hole 32 and the short circuit contact hole CNT, respectively. The drain electrode DE is exposed through the drain contact hole 32.

The insulating interlayer 320 may include an inorganic insulating material such as silicon nitride (SiNₓ) or silicon oxide (SiOₓ), or may include an organic layer. In addition, the insulating interlayer 320 may have a double-layer structure including a lower inorganic layer and an upper organic layer. The insulating interlayer 320 may have a thickness greater than or equal to about 5000 Å, e.g., in a range of about 6000 Å to about 8000 Å.

The first color filter 351 and the second color filter 352 are disposed on the insulating interlayer 320. An edge of the first and second color filters 351 and 352 may be disposed on the gate line GL, the TFT, and the data line DL. Edges of first and second color filters 351 and 352 that are adjacent to each other may overlap each other. Each of the first and second color filters 351 and 352 has an aperture defined corresponding to the drain electrode DE. Each of the first and second color filters 351 and 352 may include or be formed of a photosensitive organic material.

The first color filter 351 and the second color filter 352 have different colors from each other, and may each be one of a red color filter, a green color filter, a blue color filter, a cyan color filter, a magenta color filter, a yellow color filter, and a white color filter.

Although not illustrated in FIG. 3, the first exemplary embodiment of the LCD device 101 may further include a third color filter. The third color filter may have a different color from colors of the first and second color filters 351 and 352, and may have one of red, green, blue, cyan, magenta, and yellow colors.

The organic layer 391 is disposed on the first and second color filters 351 and 352 and the insulating interlayer 320. In such an exemplary embodiment, the organic layer 391 may be disposed over the entire surface of the first substrate 301 including being disposed over the first and second color filters 351 and 352 and the insulating interlayer 320. However, referring to FIGS. 3 and 5, the organic layer 391 may have apertures respectively defined corresponding to the drain contact hole 32 and the short circuit contact hole CNT.

The organic layer 391 may planarize a portion below the pixel electrode PE. In addition, the organic layer 391 may function as a passivation layer to protect the first and second color filters 351 and 352 and wirings below the first and second color filters 351 and 352. Accordingly, the organic layer 391 may also be referred to as a passivation layer. The organic layer 391 may include an organic material, e.g., a photosensitive organic material or a photosensitive resin composition.

The pixel electrode PE is connected to the drain electrode DE through the drain contact hole 32. The pixel electrode PE is disposed on the organic layer 391. A portion of the pixel electrode PE may overlap the light blocking portion 376. The pixel electrode PE may include or be formed of a transparent conductive material, such as indium tin oxide (ITO) or indium zinc oxide (IZO). In such an exemplary embodiment, ITO may be a polycrystalline or monocrystalline material, and IZO may be a polycrystalline or monocrystalline material as well.

The light blocking portion 376 is disposed on the pixel electrode PE and the organic layer 391. For example, the light blocking portion 376 may overlap the TFT, the gate lines GL, and the data line DL to prevent light leakage.

As illustrated in FIG. 3, a column spacer 472 may be disposed on the light blocking portion 376. The column spacer 472 has a shape protruding toward the opposing substrate 220 from the light blocking portion 376, having a predetermined height. The column spacer 472 maintains a cell gap between the display substrate 210 and the opposing substrate 220.

The column spacer 472 and the light blocking portion 376 may be unitary. In such an exemplary embodiment, the column spacer 472 and the light blocking portion 376 may be simultaneously formed using a same material. The column spacer 472 and the light blocking portion 376 may be collectively referred to as a black column spacer (BCS).

The opposing substrate 220 includes a second substrate 302 and the common electrode CE on the second substrate 302.

The common electrode CE of the opposing substrate 220 is connected to the common voltage applying line 166 of the first substrate 301 through the short circuit unit 600 to receive a common voltage from the common voltage applying line 166.

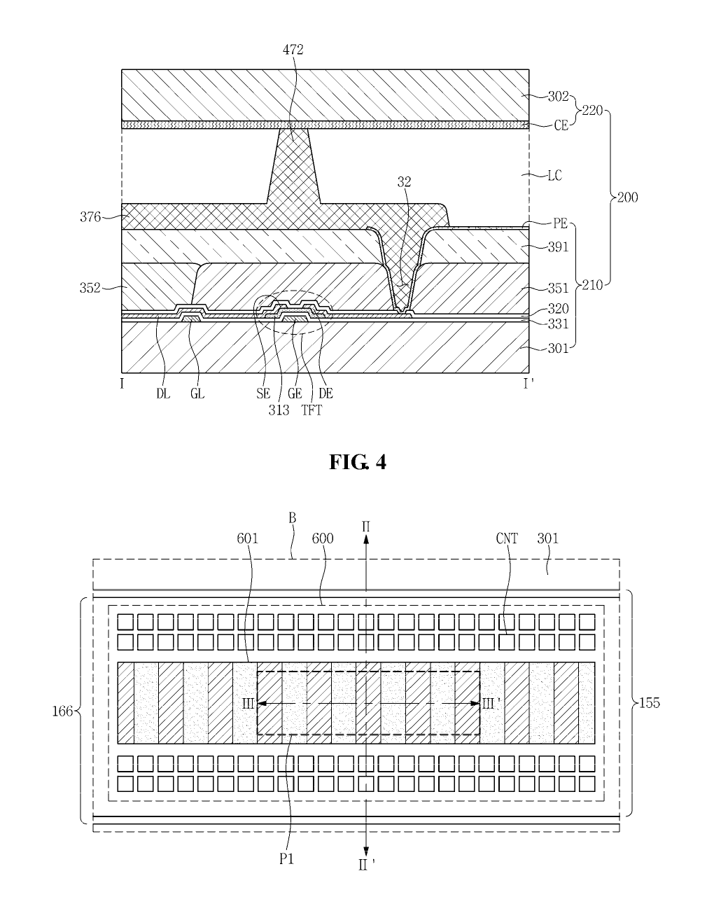

Hereinafter, the short circuit unit 600 will be described in detail with reference to FIGS. 4, 5, 6, 7A, and 7B.

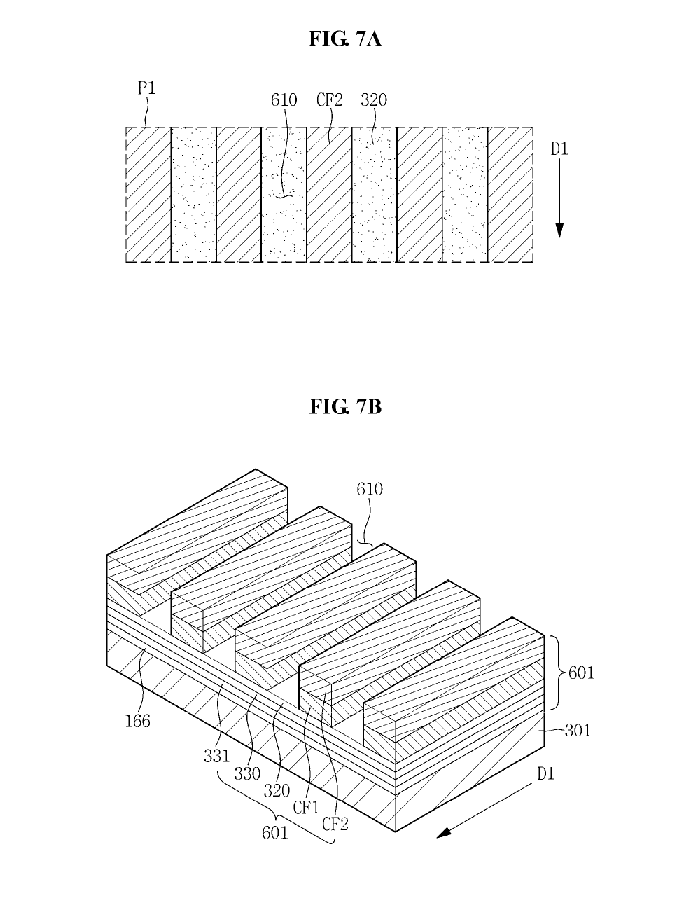

FIG. 4 is a plan view illustrating an area “B” of FIG. 1, FIG. 5 is a cross-sectional view taken along line II-IP of FIG. 4, FIG. 6 is a cross-sectional view taken along line III-III′ of FIG. 4, FIG. 7A is an enlarged plan view illustrating a portion “P1” of FIG. 4, and FIG. 7B is a perspective view illustrating the portion “P1” of FIG. 4.

According to the first exemplary embodiment, the short circuit unit 600 includes a protruding portion 601 and a short circuit electrode 602. In addition, the short circuit unit 600 may include the organic layer 391 between the protruding portion 601 and the short circuit electrode 602.

The short circuit electrode 602 is disposed on the protruding portion 601, and is electrically connected to the common voltage applying line 166 and the common electrode CE. For example, the short circuit electrode 602 is connected to the common voltage applying line 166 through the short circuit contact hole CNT, and is connected to the common electrode CE through a conductive ball 700 included in the sealing portion 155. The short circuit electrode 602 may include a same material as that included in the pixel electrode PE.

The protruding portion 601 is disposed on the common voltage applying line 166, and includes at least one dummy color filter CF1 and CF2 defining a groove 610. The groove 610 may be defined by removing at least a portion of the dummy color filter CF1 and CF2. In addition, the at least one dummy color filter CF1 and CF2 may include at least one of a red color filter, a green color filter, and a blue color filter.

Referring to FIGS. 5 and 6, the protruding portion 601 may include a plurality of layers which are formed when manufacturing the display substrate 210. A first exemplary embodiment of the protruding portion 601 includes the gate insulating layer 331, the conductive layer 330, the insulating interlayer 320, a first dummy color filter CF1, and a second dummy color filter CF2.

The conductive layer 330, the drain electrode DE, and the source electrode SE may include a same material and may be simultaneously formed in a same process. The conductive layer 330 is disposed on a same layer as a layer on which the data line DL is disposed. In addition, the semiconductor layer 313 may be disposed between the conductive layer 330 and the gate insulating layer 331 (not illustrated).

Referring to FIG. 6, a portion of the first dummy color filter CF1 and the second dummy color filter CF2 is removed such that the groove 610 is defined. The groove 610 passes through a portion of the first dummy color filter CF1 and the second dummy color filter CF2.

The first dummy color filter CF1 and the second dummy color filter CF2 may include same materials as and may be simultaneously formed in same processes with respective ones of the first color filter 351 and the second color filter 352 in the display area AR1. The first dummy color filter CF1 and the second dummy color filter CF2 may not be configured to display an image.

Each of the first dummy color filter CF1 and the second dummy color filter CF2 may be one of a red color filter, a green color filter, and a blue color filter. One of the first dummy color filter CF1 and the second dummy color filter CF2 may be a white color filter. In addition, a portion of at least one of the red color filter, the green color filter, and the blue color filter in the non-display area AR2 may be removed to define the groove 610.

Referring to FIGS. 7A and 7B, the groove 610 has a slit shape. For example, the groove 610 may have a quadrangular cross-section, and may have a slit shape extending from the non-display area AR2 toward the display area AR1. However, the cross-section of the groove 610 is not limited to the quadrangular shape. The cross-section of the groove 610 may have one of an elliptical shape, a semi-elliptical shape, a reverse triangular shape, and a portion of a polygonal shape.

An organic material for forming the organic layer 391 may move through the groove 610. In order for the organic material to move through the groove 610 smoothly, the groove 610 may have a width w1 ranging from about 1 μm to about 10 μm and a depth d1 ranging from about 0.5 μm to about 3 μm.

In the groove 610 having a slit shape, a size of a cross-section of the display area AR1 may be substantially the same as or different from a size of a cross-section of the non-display area AR2. In the groove 610 having a slit shape, the cross-section of the display area AR1 may be larger than or less than the cross-section of the non-display area AR2.

The short circuit unit 600 may have a predetermined height h1 with respect to a surface of the first substrate 301, in order for the short circuit electrode 602 to be connected to the common electrode CE readily.

The light blocking portion 376 on the display substrate 210 has a predetermined height h2. For example, in a black column spacer (BCS) structure in which the column spacer 472 and the light blocking portion 376 are simultaneously formed together, the light blocking portion 376 may have the height h2 ranging from about 3 μm to about 6 μm with respect to the surface of the first substrate 301. In an exemplary embodiment, referring to FIG. 5, the short circuit electrode 602 of the short circuit unit 600 is connected to the common electrode CE through the conductive ball 700 included in the sealing portion 155.

In a case where the short circuit unit 600 has a lesser height than a height of the light blocking portion 376 with respect to the surface of the first substrate 301, the conductive balls 700 included in the sealing portion 155 between the light blocking portion 376 and the common electrode CE are relatively sufficiently pressed, while the conductive balls 700 between the short circuit unit 600 and the common electrode CE are not sufficiently pressed, such that a connection defect may occur between the short circuit unit 600 and the common electrode CE.

In order to prevent the connection defect, the first exemplary embodiment of the short circuit unit 600 may have a greater height h1 than a height of the light blocking portion 376 with respect to the surface of the first substrate 301. That is, since including the dummy color filters CF1 and CF2 on the protruding portion 601, the short circuit unit 600 may have a greater height h1 than a height of the light blocking portion 376 with respect to the surface of the first substrate 301. Accordingly, the short circuit unit 600 protrudes from the light blocking portion 376 such that the conductive balls 700 between the short circuit unit 600 and the common electrode CE are sufficiently pressed, and thus stable electric connection may be achieved between the short circuit unit 600 and the common electrode CE.

In order to achieve stable electric connection, for example, the short circuit unit 600 may have the height h1 ranging from about 4.5 μm to about 9.0 μm with respect to the surface of the first substrate 301. However, the height of the short circuit unit 600 is not limited thereto. The height of the short circuit unit 600 may vary based on a size of the display device. For example, the short circuit unit may have a height ranging from about 6 μm to about 8 μm.

In addition, as the protruding portion 601 defines the groove 610, generation of voids or pores is suppressed during a process of coating the organic material for forming the organic layer 391.

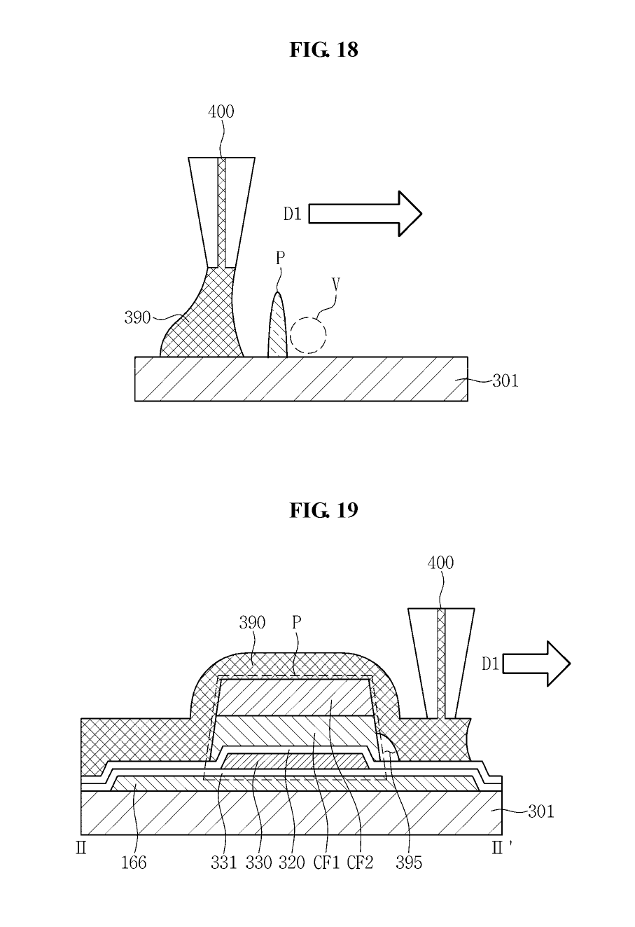

Referring to FIGS. 7A and 7B, the groove 610 extends along a direction D1 toward the display area AR1 from the non-display area AR2. In a case where the organic material for forming the organic layer 391 is coated along the direction D1, although the protruding portion 601 is present, the organic material is smoothly dispersed because the groove is defined in the protruding portion 601, such that a void, e.g., a pore, may not be generated in the protruding portion 601. Coating of the organic material and prevention of the voids will be described hereinbelow (refer to FIGS. 18 and 19).

Hereinafter, second, third, fourth, fifth, sixth, seventh, eighth, ninth, tenth, and eleventh exemplary embodiments will be described with reference to accompanying drawings. In order to avoid repetition, descriptions pertaining to the repeated configurations will be omitted.

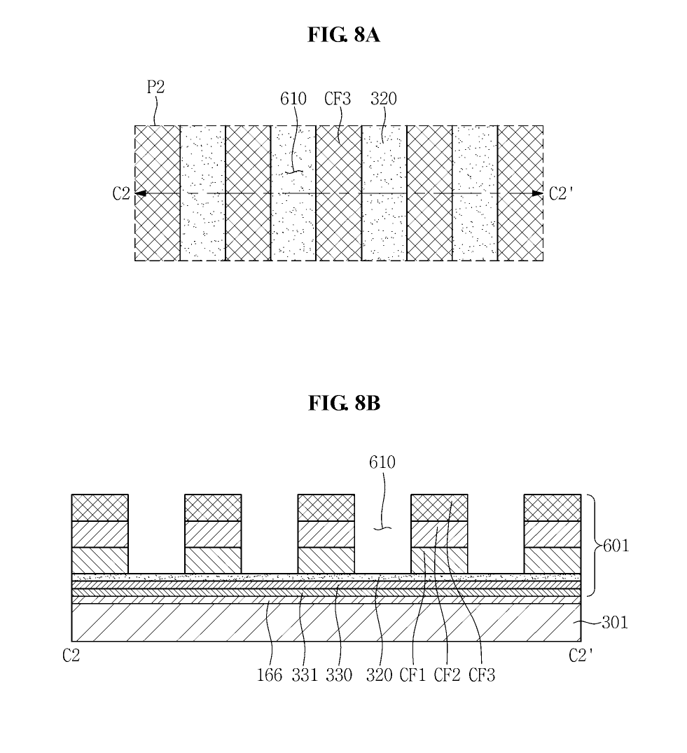

FIG. 8A is a plan view illustrating a protruding portion of a second exemplary embodiment of a display device, and FIG. 8B is a cross-sectional view taken along line C2-C2′ of FIG. 8A.

A portion P2 of FIG. 8A is a protruding portion area analogous to the portion P1 of FIG. 4.

Referring to FIGS. 8A and 8B, a protruding portion 601 of the second exemplary embodiment of a display device includes a first dummy color filter CF1, a second dummy color filter CF2, and a third dummy color filter CF3, and defines a groove 610 which is defined by removing a portion of each of the first dummy color filter CF1, the second dummy color filter CF2, and the third dummy color filter CF3.

The first dummy color filter CF1, the second dummy color filter CF2, and the third dummy color filter CF3 may include same materials as and may be simultaneously formed in same processes with respective ones of a first color filter 351, a second color filter 352, and a third color filter (not illustrated) in a display area AR1. Each of the first dummy color filter CF1, the second dummy color filter CF2, and the third dummy color filter CF3 may be one of a red color filter, a green color filter, and a blue color filter and may have different colors from each other.

According to the second exemplary embodiment, the groove 610 passes through a portion of the first dummy color filter CF1, the second dummy color filter CF2, and the third dummy color filter CF3. In such an exemplary embodiment, the groove 610 may have a quadrangular cross-section, and may have a slit shape extending from a non-display area AR2 toward the display area AR1.

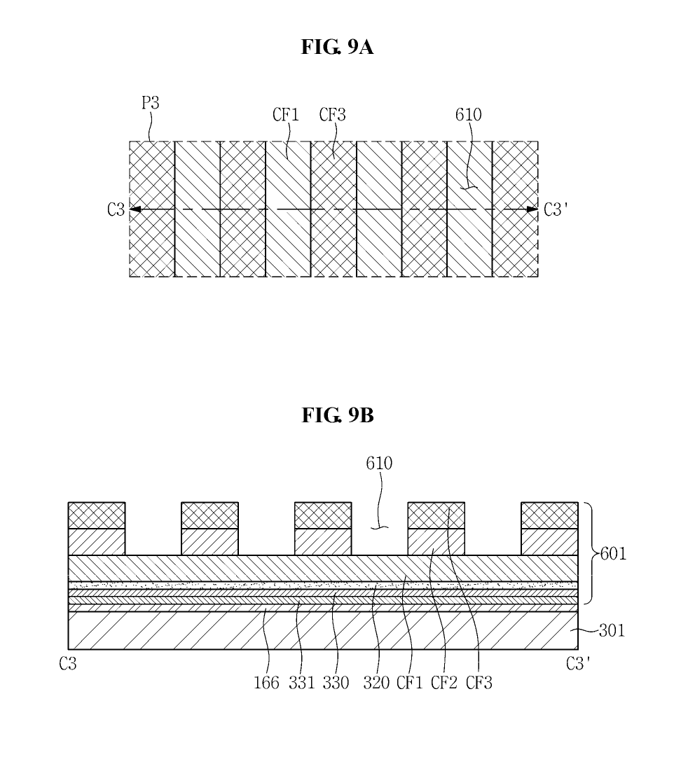

FIG. 9A is a plan view illustrating a protruding portion of a third exemplary embodiment of a display device, and FIG. 9B is a cross-sectional view taken along line C3-C3′ of FIG. 9A.

A portion P3 of FIG. 9A is a protruding portion area analogous to the portion P1 of FIG. 4.

Referring to FIGS. 9A and 9B, a protruding portion 601 of the third exemplary embodiment of a display device includes a first dummy color filter CF1, a second dummy color filter CF2, and a third dummy color filter CF3, and defines a groove 610 which is defined by removing a portion of each of the second dummy color filter CF2 and the third dummy color filter CF3. Each of the first dummy color filter CF1, the second dummy color filter CF2, and the third dummy color filter CF3 may be one of a red color filter, a green color filter, and a blue color filter and may have different colors from each other.

According to the third exemplary embodiment, the groove 610 passes through a portion of the second dummy color filter CF2 and the third dummy color filter CF3. In such an exemplary embodiment, the groove 610 may have a quadrangular cross-section, and may have a slit shape extending from a non-display area AR2 toward a display area AR1.

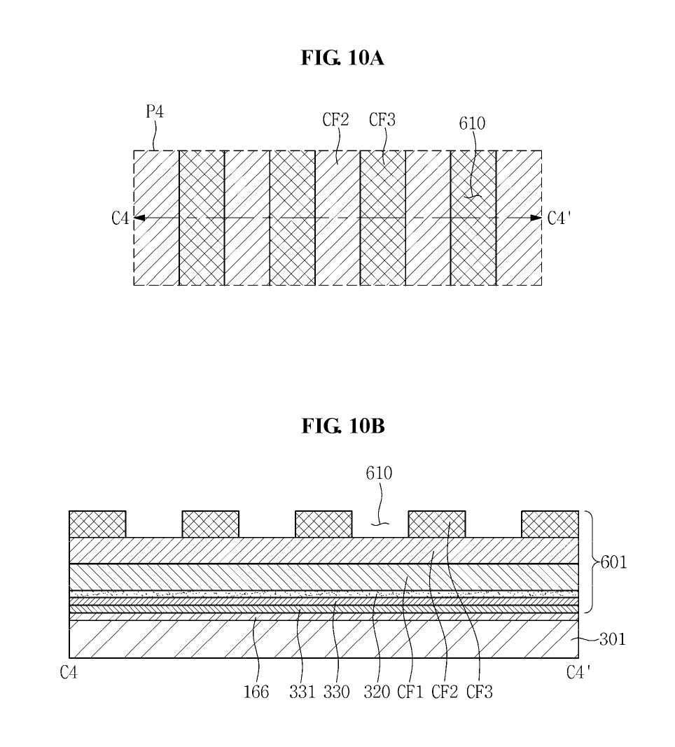

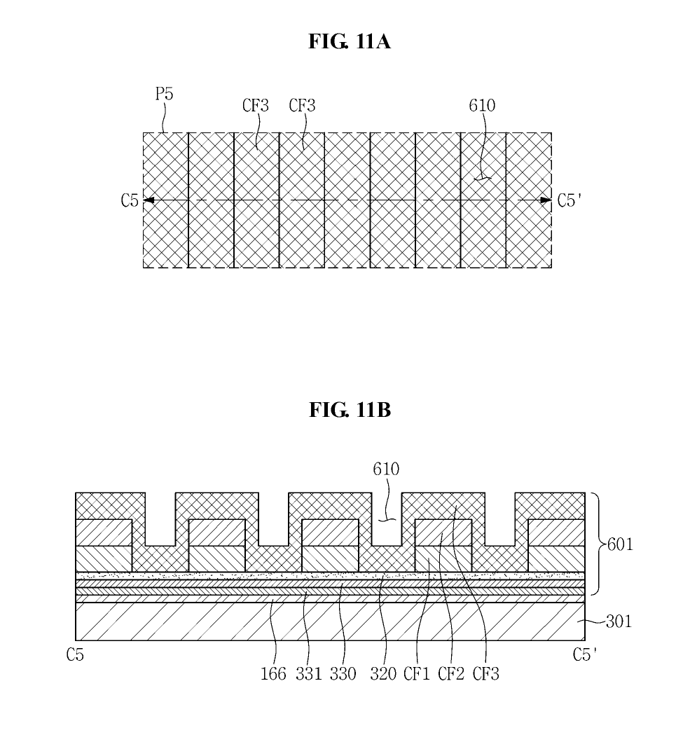

FIG. 10A is a plan view illustrating a protruding portion of a fourth exemplary embodiment of a display device, and FIG. 10B is a cross-sectional view taken along line C4-C4′ of FIG. 10A.

A portion P4 of FIG. 10A is a protruding portion area analogous to the portion P1 of FIG. 4.

Referring to FIGS. 10A and 10B, a protruding portion 601 of the fourth exemplary embodiment of a display device includes a first dummy color filter CF1, a second dummy color filter CF2, and a third dummy color filter CF3, and defines a groove 610 which is defined by removing a portion of the third dummy color filter CF3. Each of the first dummy color filter CF1, the second dummy color filter CF2, and the third dummy color filter CF3 may be one of a red color filter, a green color filter, and a blue color filter and may have different colors from each other. The third dummy color filter CF3 provided in an uppermost layer may be, for example, a blue color filter.

According to the fourth exemplary embodiment, the groove 610 passes through a portion of the third dummy color filter CF3. That is, the groove 610 is defined by removing a portion of the third dummy color filter CF3, which is provided as the uppermost layer with respect to the first substrate 301 and among the first, second, and third dummy color filters CF1, CF2, and CF3. In such an exemplary embodiment, the groove 610 may have a quadrangular cross-section, and may have a slit shape extending from a non-display area AR2 toward a display area AR1.

FIG. 11A is a plan view illustrating a protruding portion of a fifth exemplary embodiment of a display device, and FIG. 11B is a cross-sectional view taken along line C5-C5′ of FIG. 11A.

A portion P5 of FIG. 11A is a protruding portion area analogous to the portion P1 of FIG. 4.

Referring to FIGS. 11A and 11B, a protruding portion 601 of the fifth exemplary embodiment of a display device includes a first dummy color filter CF1, a second dummy color filter CF2, and a third dummy color filter CF3, and defines a groove 610 which is defined by removing a portion of each of the first dummy color filter CF1 and the second dummy color filter CF2. In addition, the third dummy color filter CF3 is disposed on the second dummy color filter CF2 and in the groove 610. With respect to a plan view (refer to FIG. 11A) which is viewed from the above, the third dummy color filter CF3 is disposed over an entire surface of the protruding portion 601.

Each of the first dummy color filter CF1, the second dummy color filter CF2, and the third dummy color filter CF3 may be one of a red color filter, a green color filter, and a blue color filter and may have different colors from each other. The blue color filter has excellent light blocking characteristics, and thus the blue color filter may be disposed in an uppermost layer of the first, second, and third dummy color filters CF1, CF2, and CF3.

In such an exemplary embodiment, the groove 610 may have a quadrangular cross-section, and may have a slit shape extending from a non-display area AR2 toward a display area AR1.

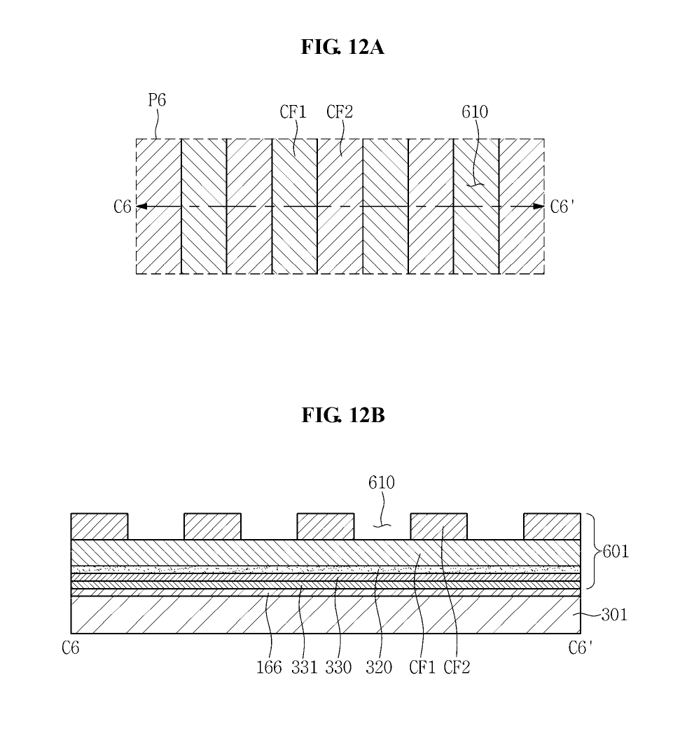

FIG. 12A is a plan view illustrating a protruding portion of a sixth exemplary embodiment of a display device, and FIG. 12B is a cross-sectional view taken along line C6-C6′ of FIG. 12A.

A portion P6 of FIG. 12A is a protruding portion area analogous to the portion P1 of FIG. 4.

Referring to FIGS. 12A and 12B, a protruding portion 601 of the sixth exemplary embodiment of a display device includes a first dummy color filter CF1 and a second dummy color filter CF2, and defines a groove 610 which is defined by removing a portion of the second dummy color filter CF2.

Each of the first dummy color filter CF1 and the second dummy color filter CF2 may be one of a red color filter, a green color filter, and a blue color filter and may have different colors from each other. In such an exemplary embodiment, the second dummy color filter CF2 may use a blue color filter.

Referring to FIG. 12A, the groove 610 may have a quadrangular cross-section, and may have a slit shape extending from a non-display area AR2 toward a display area AR1.

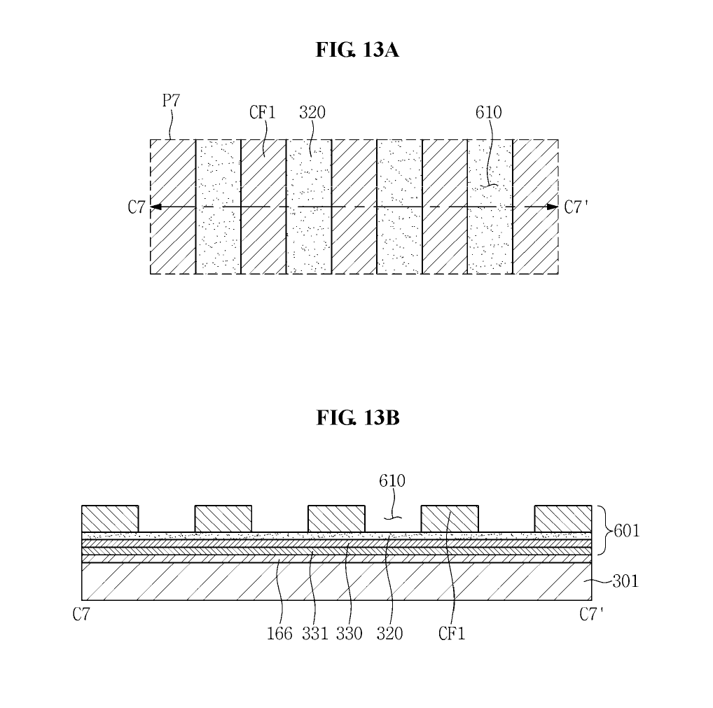

FIG. 13A is a plan view illustrating a protruding portion of a seventh exemplary embodiment of a display device, and FIG. 13B is a cross-sectional view taken along line C7-C7′ of FIG. 13A.

A portion P7 of FIG. 13A is a protruding portion area analogous to the portion P1 of FIG. 4.

Referring to FIGS. 13A and 13B, a protruding portion 601 of the seventh exemplary embodiment of a display device includes a first dummy color filter CF1, and defines a groove 610 which is defined by removing a portion of the first dummy color filter CF1.

The first dummy color filter CF1 may be one of a red color filter, a green color filter, and a blue color filter. For example, the first dummy color filter CF1 may use a blue color filter.

Referring to FIG. 13A, the groove 610 may have a quadrangular cross-section, and may have a slit shape extending from a non-display area AR2 toward a display area AR1.

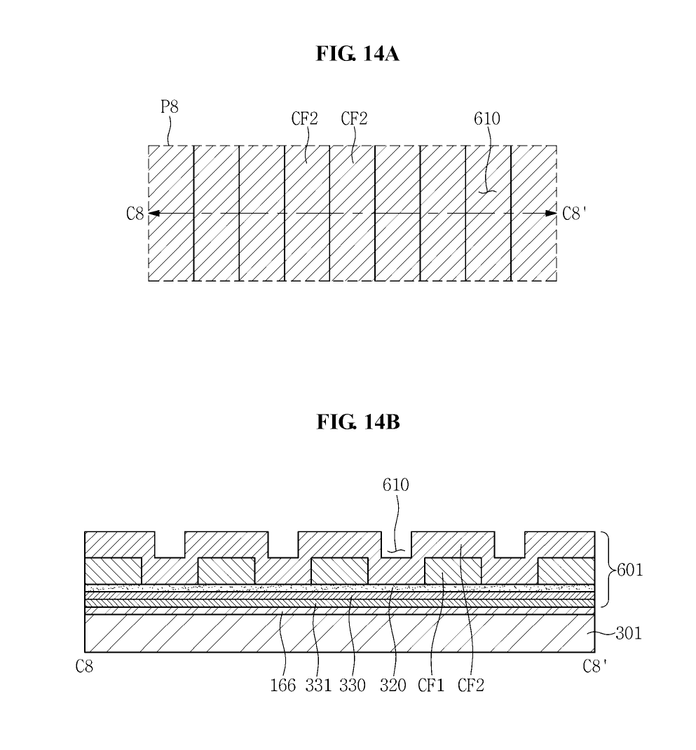

FIG. 14A is a plan view illustrating a protruding portion of an eighth exemplary embodiment of a display device, and FIG. 14B is a cross-sectional view taken along line C8-C8′ of FIG. 14A.

A portion P8 of FIG. 14A is a protruding portion area analogous to the portion P1 of FIG. 4.

Referring to FIGS. 14A and 14B, a protruding portion 601 of the eighth exemplary embodiment of a display device includes a first dummy color filter CF1 and a second dummy color filter CF2, and defines a groove 610 which is defined by removing a portion of the first dummy color filter CF1. In addition, the second dummy color filter CF2 is disposed on the first dummy color filter CF1 and in the groove 610. With respect to a plan view (refer to FIG. 14A) which is viewed from the above, the second dummy color filter CF2 is disposed over an entire surface of the protruding portion 601. Referring to FIG. 14B, the groove 610 has a side wall, and the second dummy color filter CF2 covers the side wall of the groove 610.

Each of the first dummy color filter CF1 and the second dummy color filter CF2 may be one of a red color filter, a green color filter, and a blue color filter and may have different colors from each other. The blue color filter has excellent light blocking characteristics, and thus the second dummy color filter CF2 may use a blue color filter.

In such an exemplary embodiment, the groove 610 may have a quadrangular cross-section, and may have a slit shape extending from a non-display area AR2 toward a display area AR1.

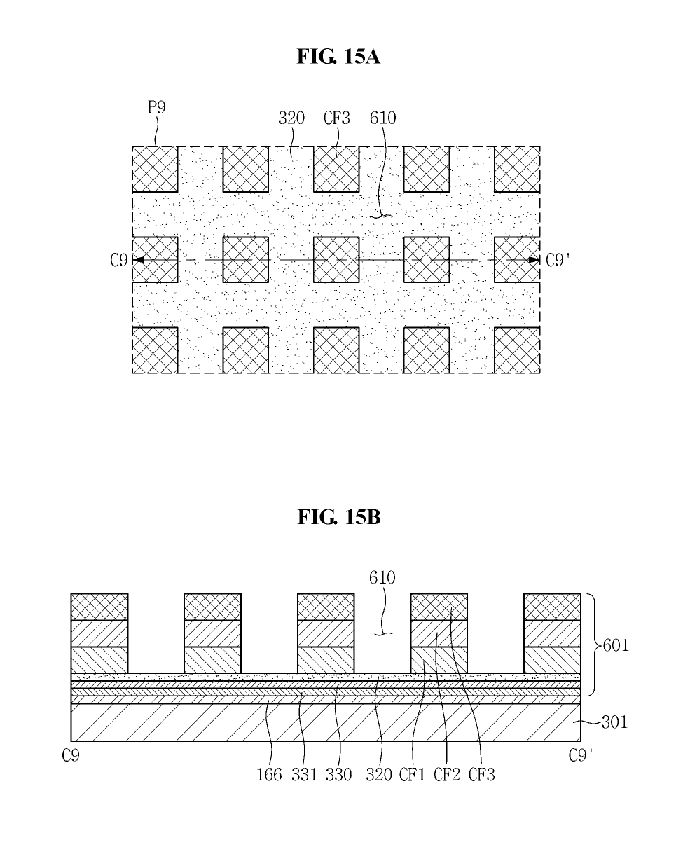

FIG. 15A is a plan view illustrating a protruding portion of a ninth exemplary embodiment of a display device, and FIG. 15B is a cross-sectional view taken along line C9-C9′ of FIG. 15A.

A portion P9 of FIG. 15A is a protruding portion area analogous to the portion P1 of FIG. 4.

According to the ninth exemplary embodiment, a groove 610 has a mesh shape, and first, second, and third dummy color filters CF1, CF2, and CF3 are disposed in an island shape.

Referring to FIGS. 15A and 15B, a protruding portion 601 of the ninth exemplary embodiment of a display device includes the first dummy color filter CF1, the second dummy color filter CF2, and the third dummy color filter CF3, and defines a groove 610 which is defined by removing a portion of each of the first dummy color filter CF1, the second dummy color filter CF2, and the third dummy color filter CF3.

The groove 610 has a mesh shape passing through a portion of the first dummy color filter CF1, the second dummy color filter CF2, and the third dummy color filter CF3, and a stacked structure in which the first dummy color filter CF1, the second dummy color filter CF2, and the third dummy color filter CF3 are stacked is disposed as an island shape to support a short circuit electrode 602.

Each of the first dummy color filter CF1, the second dummy color filter CF2, and the third dummy color filter CF3 may be one of a red color filter, a green color filter, and a blue color filter and may have different colors from each other.

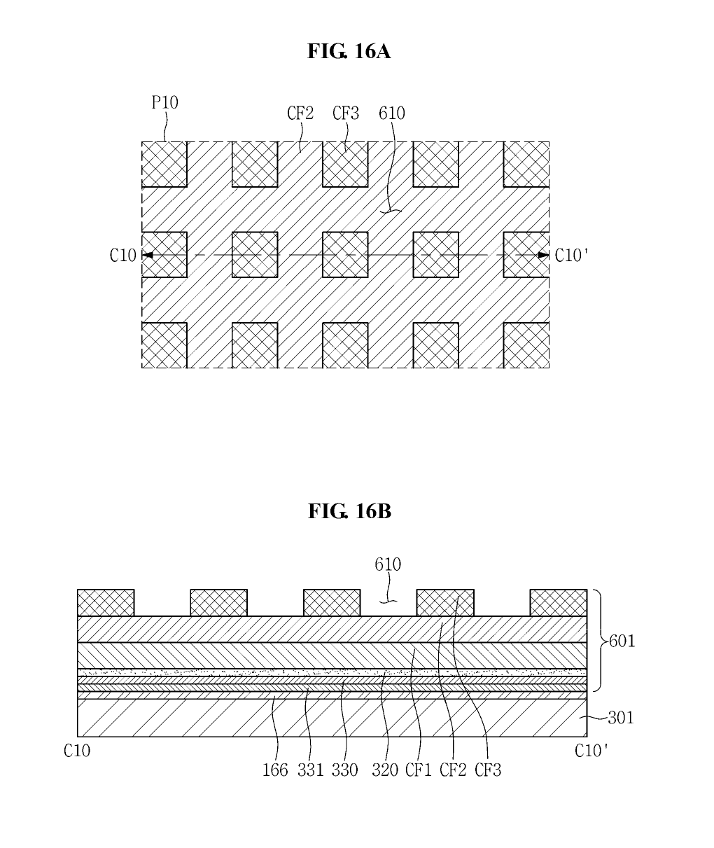

FIG. 16A is a plan view illustrating a protruding portion of a tenth exemplary embodiment of a display device, and FIG. 16B is a cross-sectional view taken along line C10-C10′ of FIG. 16A.

A portion P10 of FIG. 16A is a protruding portion area analogous to the portion P1 of FIG. 4.

Referring to FIGS. 16A and 16B, a protruding portion 601 of the tenth exemplary embodiment of a display device includes a first dummy color filter CF1, a second dummy color filter CF2, and a third dummy color filter CF3, and defines a groove 610 which is defined by removing a portion of the third dummy color filter CF3 which is an uppermost layer.

According to the tenth exemplary embodiment, the groove 610 has a mesh shape passing through a portion of the third dummy color filter CF3, and the third dummy color filter CF3 is disposed as an island shape on the first dummy color filter CF1 and the second dummy color filter CF2.

Each of the first dummy color filter CF1, the second dummy color filter CF2, and the third dummy color filter CF3 may be one of a red color filter, a green color filter, and a blue color filter and may have different colors from each other.

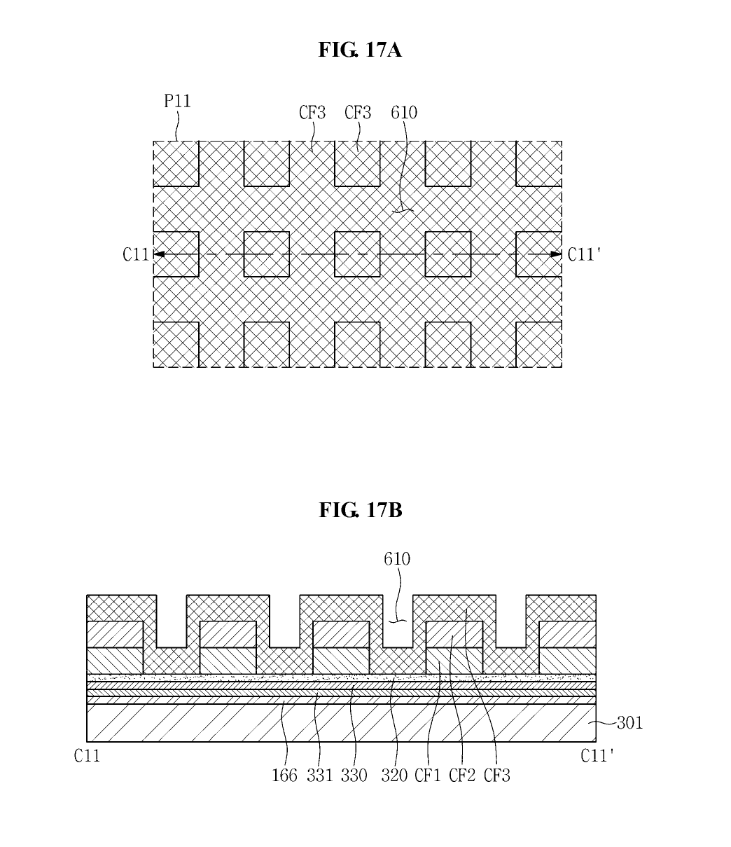

FIG. 17A is a plan view illustrating a protruding portion of an eleventh exemplary embodiment of a display device, and FIG. 17B is a cross-sectional view taken along line C11-C11′ of FIG. 17A.

A portion P11 of FIG. 17A is a protruding portion area analogous to the portion P1 of FIG. 4.

Referring to FIGS. 17A and 17B, a protruding portion 601 of the eleventh exemplary embodiment of a display device includes a first dummy color filter CF1, a second dummy color filter CF2, and a third dummy color filter CF3, and defines a groove 610 which is defined by removing a portion of each of the first dummy color filter CF1 and the second dummy color filter CF2.

The groove 610 has a mesh shape passing through the first dummy color filter CF1 and the second dummy color filter CF2, and the first dummy color filter CF1 and the second dummy color filter CF2 are disposed as an island shape on the first substrate 301. The third dummy color filter CF3 is disposed on the second dummy color filter CF2 and in the groove 610. With respect to a plan view (refer to FIG. 17A) which is viewed from the above, the third dummy color filter CF3 is disposed over an entire surface of the protruding portion 601.

Each of the first dummy color filter CF1, the second dummy color filter CF2, and the third dummy color filter CF3 may be one of a red color filter, a green color filter, and a blue color filter and may have different colors from each other. The blue color filter has excellent light blocking characteristics, and thus the third dummy color filter CF3 may use a blue color filter.

FIG. 18 is a cross-sectional view illustrating an example of coating an organic material, and FIG. 19 is a cross-sectional view illustrating an example of pores 395 being generated in the process of coating the organic material.

The first exemplary embodiment of the LCD device includes the organic layer 391 which is used as a passivation layer or an insulating layer. The organic layer 391 may be formed by coating an organic material 390. The organic material 390 for forming the organic layer 391 has a predetermined degree of viscosity and thus may have a limitation in spreadability.

Referring to FIG. 18, the organic material 390 for forming the organic layer 391 is coated over the first substrate 301 along a direction D1 by a slit coater 400. In a case where an obstruction such as a protrusion pattern P is present in a proceeding direction of the slit coater 400, the organic material 390 does not smoothly spread in an area adjacent to the protrusion pattern P such that a pore, e.g., a void V, may be generated in the area adjacent to the protrusion pattern P. For example, the void V may be generated in the area adjacent to the protrusion pattern P after the slit coater 400 passes through.

Referring to FIG. 19, in a case where the organic material 390 is coated over a protrusion pattern P that has a similar structure as a structure of the first exemplary embodiment of the protruding portion 601 but does not define a groove 610, a pore 395, e.g., a void, may be generated in an area adjacent to the protrusion pattern P. The pore 395 may be recognized by a user as a deterioration of display quality of the display device.

According to exemplary embodiments, as the groove 610 is defined in the protruding portion 601, the organic material 390 may smoothly spread such that a pore 395, e.g., a void, may not be generated in an area adjacent to the protruding portion 601. Accordingly, exemplary embodiments of the display device may have high display quality without experiencing visibility degradation due to pores.

As set forth above, according to one or more exemplary embodiments, a display device includes an organic layer which is formed substantially not including pores and is improved in terms of display quality.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings. Various features of the above described and other embodiments can be mixed and matched in any manner, to produce further embodiments consistent with the invention.

What is claimed is:

1. A display device comprising:
a first substrate and a second substrate opposing each other;
a common voltage applying line on the first substrate;
a common electrode on the second substrate; and
a short circuit unit between the common voltage applying line and the common electrode,
wherein the short circuit unit comprises:
a protruding portion on the common voltage applying line; and
a short circuit electrode on the protruding portion,
wherein the protruding portion comprises at least one dummy color filter defining a groove, and
wherein the short circuit electrode is electrically connected to the common voltage applying line and the common electrode.

2. The display device as claimed in claim 1, wherein the groove is defined by removing at least a portion of the at least one dummy color filter.

3. The display device as claimed in claim 2, wherein the at least one dummy color filter comprises at least one of a red color filter, a green color filter, and a blue color filter.

4. The display device as claimed in claim 1, wherein the groove has a slit shape.

5. The display device as claimed in claim 4, wherein the first substrate comprises a display area and a non-display area, and
the slit shape extends from the non-display area toward the display area.

6. The display device as claimed in claim 1, wherein the groove has a mesh shape, and
the at least one dummy color filter is disposed in an island shape.

7. The display device as claimed in claim 1, wherein the groove has a width ranging from about 1 μm to about 10 μm.

8. The display device as claimed in claim 1, wherein the groove has a depth ranging from about 0.5 μm to about 3 μm.

9. The display device as claimed in claim 1, wherein the first substrate comprises a display area and a non-display area, and
the short circuit unit is disposed in the non-display area.

10. The display device as claimed in claim 1, wherein the short circuit unit further comprises an organic layer between the protruding portion and the short circuit electrode.

11. The display device as claimed in claim 10, wherein the organic layer is a passivation layer.

12. The display device as claimed in claim 1, further comprising a sealing portion between the short circuit unit and the common electrode, and
wherein the sealing portion comprises a conductive ball.

13. The display device as claimed in claim 1, further comprising a light blocking portion on the first substrate,
wherein the short circuit unit has a greater height than a height of the light blocking portion with respect to a surface of the first substrate.

14. The display device as claimed in claim 1, wherein the short circuit unit has a height ranging from about 4.5 μm to about 9.0 μm with respect to a surface of the first substrate.

15. The display device as claimed in claim 1, further comprising a data line and a gate line on the first substrate,
wherein the common voltage applying line is disposed on a same layer as a layer on which the gate line is disposed.

16. The display device as claimed in claim 15, wherein the protruding portion further comprises a gate insulating layer on the common voltage applying line and a conductive layer on the gate insulating layer, and
the conductive layer is disposed on a same layer as a layer on which the data line is disposed.

17. The display device as claimed in claim 1, further comprising a liquid crystal layer between the first substrate and the second substrate.

18. A display device comprising:
a first substrate and a second substrate opposing each other;
a common voltage applying line on the first substrate;
a common electrode on the second substrate; and
a short circuit unit between the common voltage applying line and the common electrode,
wherein the short circuit unit comprises:
a protruding portion on the common voltage applying line; and
a short circuit electrode disposed on the protruding portion and electrically connected to the common voltage applying line and the common electrode, and
wherein the protruding portion comprises:
a first dummy color filter on the common voltage applying line;
a second dummy color filter on the first dummy color filter; and
a groove which is defined by removing at least a portion of at least one of the first dummy color filter and the second dummy color filter.

19. The display device as claimed in claim 18, wherein each of the first dummy color filter and the second dummy color filter is one of a red color filter, a green color filter, and a blue color filter.

20. The display device as claimed in claim 18, wherein the groove passes through the first dummy color filter and the second dummy color filter.

21. The display device as claimed in claim 18, wherein the groove is defined by removing at least a portion of the first dummy color filter, and
the second dummy color filter is disposed on the first color filter and in the groove.

22. The display device as claimed in claim 21, wherein the second dummy color filter covers a side wall of the groove.

23. The display device as claimed in claim 18, wherein the groove has a slit shape.

24. The display device as claimed in claim 18, further comprising a light blocking portion on the first substrate,
wherein the short circuit unit has a greater height than a height of the light blocking portion with respect to a surface of the first substrate.
